(19) United States
(12) Patent Application Publication
(10) Pub. No.: US 2007/0054696 A1
(43) Pub. Date: Mar. 8, 2007

(54) Wireless terminal and method of using same

(76) Inventors: Jason R. Cooner, Birmingham, AL (US); Ron J. Holbrook, Pinson, AL (US)

Correspondence Address: WARNER J DELAUNE JR;ADAMS AND REESE LLP, 450 LAUREL STREET, SUITE 1900, BATON ROUGE, LA, 70801, US

(21) Appl. No.: 10/696,388

(22) Filed: Oct. 28, 2003

Related U.S. Application Data
(60) Provisional application No. 60/421,688, filed on Oct. 28, 2002.

(51) Int. Cl. H04B 1/38; H04M 1/00

(52) U.S. Cl. 455/557

(57) ABSTRACT

A wireless terminal device is provided for use in a wireless system, wherein the wireless terminal device is communicatively connectable to a host computer. The device comprises a case having a power supply and an input device to accept input from a user, wherein the input is directed to the host computer through a switching device connected to the host computer. The wireless terminal device further includes a visual display of information responsive to the input, and control functionality and memory relating to operations of the wireless terminal device, wherein the control functionality and memory are mounted to the case. The wireless terminal also includes a device mounted to the case for transmitting and receiving signals formatted for digital Internet Protocol (IP) data capable of being routed over a computing network, wherein the signals include an identification of the wireless terminal device, and wherein the wireless terminal device is caused to emulate the operation of the host computer.

### RELATION TO PRIOR APPLICATIONS

This nonprovisional application is based upon and claims priority to prior provisional application Ser. No. 60/421,688, filed on Oct. 28, 2002.

### BACKGROUND OF THE INVENTION

I. Field of the Invention

The present invention relates generally to devices and methods for remotely accessing and controlling computers, and more particularly to wireless devices used to emulate the operation of a remote computer.

II. Background and Prior Art

The modern networked computing environment has historically been based on systems that communicate through cables in the form of copper wire. These computer networks are known as “wireline” systems. The primary computing architecture that has been implemented in almost all modern computer networks is the Client/Server architecture. Client/Server architecture requires that the computing network have one or more servers, and many clients attached to the server(s) via networking cables and hardware to route traffic. On this type of network, software applications are distributed in two tiers. These two tiers are the client tier, responsible for providing a user interface to the application, and a server tier, responsible for handling the majority of the processing required by the application. The two tiers have to communicate with each other, which requires computer resources to manage the network communication as well as additional overhead, because the two tiers of the application are not operating in the same computer memory space. Although this architecture has proven to be capable of maintaining a computing network, there are more optimal ways of distributing applications on the latest hardware to gain better efficiencies and reduce costs associated with such systems, while gaining greater flexibility in the usage of such networks.

There has been a dramatically increased demand for computing systems that are capable of operating “wirelessly”. Computing systems can communicate in a wireless capacity by transmitting data through radio or infrared airwaves, instead of through network cables. This type of computing architecture has several key advantages. First, the computer user can move the computer around the home or corporate environment to better accommodate their workload and workspace. Additionally, home users can use wireless devices to access computing resources anywhere in their home, without any significant effort, e.g. pulling cables through walls and installing wall jacks, that would be required with a wireline system. Furthermore, the computer application layer does not have to manage network traffic, so the processing cycles of the central processing unit (CPU) have been freed up to handle more processing at the server layer of the network. In fact, many current corporate computing networks are using a Unix mainframe configuration on the backend (or server tier) of the network, and personal computers (PC's) are used for the client tier as “dumb terminals.” If such a configuration were replaced with a wireless client tier comprised of wireless terminals having minimal processing hardware, then the PC's could be removed from the network. This would not only have the benefit of reducing expenditures in network management software and manpower, but would dramatically reduce expenses associated with the client-side hardware and software licensing. The user would also benefit by having better responsiveness from the application layer, because both client and server application layers could then be run inside the same computer memory space on the server.

Another deficiency of current wireless computing platforms is that it is relatively expensive and maintenance intensive to migrate to a wireless environment. Currently, wireless computing is achieved by buying a wireless-enabled notebook computer or handheld device, such as those manufactured by Palm, Inc. This forces the user to purchase additional software licenses to run on the wireless device to enable access to remote networks. It also requires the user to purchase additional computing hardware to leverage the wireless connection point. Ideally, a wireless terminal system should be available in which the hardware costs have been minimized and the software costs have been eliminated.

In addition to the weaknesses described above, the current wireless world uses a security protocol referred to as the Wired Equivalency Protocol (WEP) that implements an encryption model. WEP was designed to provide the same level of security as that of a wired Local Area Network (LAN). However, wireless LAN's do not have the same physicalities of their structure as do wired LAN's, such as having some or all parts of the network inside of a building prevented from unauthorized access. Instead, wireless LAN's send data over radio waves and are more vulnerable to interception. The WEP model requires some of the data used to encrypt the data stream to be transmitted in “cleartext” (data in its original unencrypted form). This requirement leads to many security flaws in the encryption mechanism. In order to remove the security flaws, an encryption model is needed which does not broadcast any cleartext data and/or encryption keys.

### SUMMARY OF THE INVENTION

Most computing environments have incorporated an increasing amount of computing capacity within each device in a domain. The devices referred to include, but are not limited to, computing hardware and software found in mainframe, PC, client/server, and n-tier systems. They involve computer architectures based on both Alpha and Intel specifications, and range from local to fully distributed computing networks. Much of this additional processing capability is inaccessible, and could be utilized to increase the productivity and usability of any given computing environment. The inventions disclosed herein target specific aspects of computer processing utilization in an effort to achieve better overall usage of processing capability available in any computing system. The systems described herein are also the least expensive and most cost-effective way to achieve wireless capability currently, and with full access to an existing computing environment.

Current wireless computing devices require the user to purchase a full version of an operating system and additional software licenses to run the device wirelessly. Examples of this are a notebook computer with wireless capability through a wireless LAN card or wireless chipset or the handheld devices referred to previously. In contrast, the wireless terminal in accordance with the present invention would allow the user to have the flexibility of a fully-integrated wireless computing device at their access to perform work, but in a form that is less expensive to produce than current wireless computing devices, because it does not require a full-size notebook-style computer processor or other chipsets used in similar computing devices. The wireless terminal of the present invention would require no maintenance of a software environment or hard drive, because it would not employ such technology. All the software used in the wireless terminal is “hard coded” into chips, so that the majority of the device's construction is considered solid state. Items such as hard drives and other long-term storage devices are absent from the preferred embodiment of this device, and the computing environment does not need to be maintained by software such as disk defragmenters or client-side software management.

The wireless terminal has several unique security models that can be implemented to provide secure communications for any wireless network. All the models use a trust hierarchy in the form of predefined Public Key Infrastructure (PKI) encryption mechanisms with predefined encryption keys in use. One security model covers communication between users in a secure communication environment and users in an insecure communication environment. Two other security models involve encrypting data between users on the same or disparate secure communication networks.

In terms of the physical structure of the wireless terminal, the casing has several unique features in a preferred embodiment. For example, the casing preferably includes an integrated identification mechanism which may comprise a fingerprint scanner that is used when the device is turned on or is enabled after being inactive for a certain period of time. Other identification mechanisms include retinal scanning, smart-card readers, or voice recognition used in the same manner. Another included feature of the casing is an integrated antenna. The antenna feature preferably includes two or more antennas, one for sending and one for receiving a number of types of transmissions including cellular, Wi-Fi (Wireless Fidelity), or satellite. In a more preferred embodiment, the antennas are embedded into either side of a liquid crystal display (LCD) on the top fold of the wireless terminal. They could also extend out from the device for greater range. Additional features of the wireless terminal may comprise a detachable cellular component and a detachable power supply.

Also in a preferred embodiment, the system includes a tracking mechanism that can be used to continuously track the location of the wireless terminal or any other item of interest. The tracking feature can be used to recover the item if it becomes lost or stolen. The tracking service would employ an Internet-accessible data reporting facility, the ability to submit information to law enforcement and judicial systems, and incorporate industry standards to support integration with cellular, satellite, and hardware manufacturers globally.

### BRIEF DESCRIPTION OF THE DRAWINGS

FIG. 1 depicts a wireless terminal reference architecture, which is the basic overall design for a wireless terminal in accordance with the invention.

FIG. 2 depicts a wireless single user computer side reference architecture (PC or Server Access), which is the basic overall design for a single-user wireless access point.

FIG. 3 depicts a wireless multiple User computer side reference architecture (Server or Mainframe Access), which is the basic overall design for a multiple-user wireless access point.

FIG. 4 depicts a wireless security model reference architecture, which is an illustration of the general security model for the wireless terminal.

FIG. 5 depicts a wireless carrier security model reference architecture for external network communication, which is an illustration of a wireless security model that accesses insecure communication networks.

FIG. 6 depicts a wireless carrier security model reference architecture for internal network communication, which is an illustration of a wireless security model that can be used for users on the same communication network.

FIG. 7 depicts a wireless carrier security model reference architecture for internal network communication, which is an illustration of a wireless security model that can be used for users on the same communication network, but one in which data is sent on a secure communication channel that does not get decrypted during transmission.

FIG. 8 depicts a wireless terminal casing reference architecture, which is an illustration of a casing for the wireless terminal.

FIG. 9 depicts a wireless tracking mechanism for wireless devices and other items, which illustrates the overall operation of the tracking system.

FIG. 10 depicts the setup and operation of the wireless tracking mechanism.

### DETAILED DESCRIPTION OF THE PREFERRED EMBODIMENTS

With specific reference to the figures, the preferred embodiments of the present invention will now be described. Certain features or methods which are used in assembling or operating the invention, but which are known to those of ordinary skill in the art and not bearing upon points of novelty may not be shown or described for clarity. For the purposes of this disclosure, “wireline” means a communication networking architecture that uses wires to connect at least two devices for the transmission and reception of data. “Wireless” means a communication networking architecture wherein at least two devices transmit and receive data via electromagnetic radiation such as radio frequency energy or infrared energy. “Local” means any events or actions related to the computer which is being accessed or controlled by the wireless terminal. Conversely, “remote” means any events or actions related to the wireless terminal that accesses or controls the computer.

The wireless terminal (WT) of the present invention comprises a computer device that emulates a remote computing environment over a wireless connection. It performs as an interface to any type of host computer that uses a standard VGA type display, keyboard, mouse, audio, and other possible output sources from the host computer. Other types of input/output could also be provided (RGB or Component video, RS232 serial, etc.). The word “terminal” is used throughout this disclosure to describe the display, keyboard, mouse, audio, or other interface to a computer having a CPU, such as those terminals used in small, mid-sized, and large computer environments. The primary purpose of the WT is to provide wireless remote access to a host computer from anywhere within the range of the transmitters/receivers located in the computer and in the remote WT. The WT may provide the same level of control and access to the computer as terminal equipment (display, keyboard, mouse and audio) located at the computer. Additional supported input or output features on the WT could include external hardware interfaces for common computer functions and peripherals, such as keyboard, mouse, video, Universal Serial Bus (USB), serial, parallel, fiber, component, RJ45, RJ232, RJ11, PS2, and sound.

The computer-side hardware may include a remote access switch that consists of a switching device to switch between the local terminal hardware (such as keyboard, video, and mouse) and the remote terminal hardware (such as the WT). The remote access switch is typically referred to as a KVM switch, and is housed in a unit with a transmitter/receiver, video memory, multiplexing, or packet switching, hardware to communicate VGA, keyboard, mouse and audio data with the WT.

In a preferred embodiment, the WT includes an LCD display, keyboard, mouse, audio amplifier and speakers, transmitter/receiver and multiplexing, or packet switching, hardware. In addition to the input and output features previously described, a video output jack can be provided to interface with a television for NTSC or PAL output. The configuration may include a remote access switch that will interface with the computer via input jacks for the VGA, keyboard, mouse and audio. The WT may interface with the local hardware via output jacks for the display, keyboard, mouse and audio amplifier. The switching function switches the input from the VGA, keyboard, mouse and audio between the local hardware and a transmitter/receiver that communicates with the WT by radio frequency. In this manner, the WT can function as a remote terminal for any computer using standard VGA, keyboard, mouse and audio interface. The local interface is the switching, multiplexing, transmit and receive functions for the equipment located at the computer end of this configuration. The local operating mode for the switch is that it will use the terminal hardware located at the computer. The switch will either switch the VGA, keyboard, mouse, audio, and other signals to the local equipment via input jacks from the computer through the switch and out the output jacks to the WT, or it can constantly pass these signals through to the WT directly. If a switch is used, the remote mode (switch set to communicate with the WT) the device will switch the terminal data (VGA, keyboard, mouse and audio or other signals mentioned above) to the multiplexing, or packet switching, hardware for communications with the WT via the transmitter/receiver.

The computer-side device switch can be either a mechanical or solid-state switch that switches the VGA, keyboard, mouse and audio or other signal data from the computer input jacks to the local equipment or the communications equipment associated with the WT. This type of switching can support one or multiple computers to one terminal, or one or multiple terminals to one computer, or any other available combination on a computing network. The remote interface of the WT is a laptop-computer-like device that may contain the logic functions, memory, disk drives, etc., associated with a typical computer. The WT may also contain a battery/AC power supply, LCD display, keyboard, mouse, audio system and a transmitter/receiver with multiplexing or packet switching functionality to provide the two-way communications with the local computer. The WT may contain a CPU with or without an embedded operating system such as Linux to coordinate device components on the WT. The wireless transmitter/receiver can be used in coordination with a wireless and wireline network for greater access. In this scenario, the local hardware can be recognized on a computer network as a destination point. One possible implementation of this arrangement would be if the computer-side hardware could be assigned an Internet Protocol (IP) address that could be recognized by the computing network. This will require the data to be formatted into a true digital IP format to be routed over a network to the wireless transmitter/receiver or access point. The computer-side interface could also be implemented as an all-software solution that runs on a computer connected to the network of interest that would include network support for IP.

In summary, the WT provides the complete control of the computer as the local interface for a computer user. The WT may also have the following input and output jacks: (1) Video output jack to provide the ability to use a TV as the display portion of the terminal; (2) VGA output jack to permit the use of an external display; (3) keyboard and mouse jacks to allow the user to connect a standard mouse and keyboard to the device; (4) audio output jacks to connect an external amplifier and speakers to the device; and (5) Universal Serial Bus (USB) jacks to connect USB compatible devices to the WT.

The wireless communications service of the WT contains the transmitter/receiver and multiplexing, or packet switching, equipment necessary for the wireless terminal to communicate with the computer through the local interface. The VGA and audio portions of this device are the only services transmitted from the computer-side interface to the wireless remote terminal interface. They are multiplexed, or packet switched, over the transmit section of the computer-side interface. To allow the computer to control the display of the WT in the same manner that it now controls the local display, using the current computer display drivers, a display memory device is provided to store the display in the computer-side interface for transmission to the WT. Also, the video may be managed by the WT itself by buffering the video data in the WT itself to manage refresh rates on the LCD display. The VGA may be transmitted to the WT by frame-based digital video or raw video. Using frame-based digital video should reduce the bandwidth required for the transmission. Using raw video will eliminate the need to change the frame-based digital signal to a video output level for the video output jack of the WT interface. The audio may be transmitted over a separate frequency or multiplexed, or packet switched, over the same frequency as the video. If packet switching is used as the transport medium, all the services (VGA, keyboard, mouse and audio) may be sent over the same two-way packet switching network. The keyboard and mouse portions of the WT are the only services transmitted from the WT to the computer-side interface and can use the same frequency range of the transmitter/receiver. They are multiplexed, or packet switched, over the transmit section of the WT interface and can be transmitted over a different frequency or use two-way packet switching network. The radio frequency, or frequencies, used as a transport medium should be of a bandwidth capable of a quality delivery of the VGA whether it is a digital or analog video signal. A frequency range and wattage unregulated by the U.S. Federal Communication Commission (FCC) could be used as a transport medium. The frequency and power of the transmission should provide a good quality reception for the longest distance and through obstacles (such as walls) as possible. Several selectable bands, or some form of keyed communication, are provided to permit the use of several different devices within the reception range without interference with each other.

In a wireless system consistent with the invention, the computer includes a wireless computer interface to connect over a communication network. The computer interface can be implemented as a hardware or software implementation, and it can support a single or multiple users connecting to the same computer. The computer interface may be designed as a terminal server with wireless support for each terminal. It may also employ a server level technology known as “Blade” architecture to those of ordinary skill in the art. The computer interface may incorporate a signal booster or repeater technology to send the wireless transmission further than without such a mechanism. This repeater mechanism should be able to broadcast over one or many signal repeaters to send the signal a greater distance between the computer interface and the WT. The computer interface may require usage of external hardware interfaces which may include keyboard, mouse, video, Universal Serial Bus, serial, parallel, fiber, component, RJ45, RJ232, RJ11, PS2, and/or sound. The computer interface can support a single shared session on the computer, or multiple individual or shared sessions on the computer. The computer terminal or computer interfaces are specifically designed for wireless mobility and have built-in capability for wirelessly interfacing with 802.11 wireless communication networks. They should also have built-in capability for wirelessly interfacing with cellular communication networks, including GSM, CDMA, and TDMA based networks, as well as satellite-based communication networks, ultra-wideband wireless communication networks, and any other type of wireless or wireline communication network.

The WT may include a standard hard drive or flash memory, although this would not be strictly required, particularly if security concerns dictate that network data should not be permanently stored on the WT. Preferably, the WT includes keyboard and mouse-style input features, similar to those seen on common handheld devices, as well as a video display such as an LCD screen. Optionally, the WT includes a sound output mechanism such as onboard speakers or plugs to connect external speakers. A variety of external hardware interfaces may also be included, such as jacks for connecting external devices such as keyboard, mouse, video, Universal Serial Bus, serial, parallel, fiber, component, RJ45, RJ232, RJ11, PS2, and/or sound. The WT also preferably includes one or more stationary or extendable antennas to transmit and/or receive data. Power to the WT is provided by a rechargeable battery supply, and a separate battery may be included to maintain the system clock. Although not required, the WT may employ a standard or embedded-style CPU running an operating system such as Linux, Microsoft Windows, or Solaris.

The WT can multiplex multiple signals coming into and going out of the device. The wireless terminal can multiplex signals that include in no particular combination, but are not limited to, keyboard, mouse, video, Universal Serial Bus, serial, parallel, fiber, component, RJ45, RJ232, RJ11, PS2, and/or sound input or output. The multiplexed signals can be formatted into a true Internet Protocol (IP) based format. The data being sent between the WT and the computer interface is always in a digital format to prevent data loss. The multiplexed signals can be routed over an IP based network. The multiplexed signals can be sent over any IP-enabled hardware or software. The network used by the WT may incorporate both wireless and wireline communication networks to maintain communication between the WT and the computer being emulated. The casing for the WT is preferably modeled after a standard notebook class computer, such that the casing has two main panels, one with the keyboard and/or mouse, and another with the display. The casing for the WT may have a wide variety of covers, including but not limited to covers depicting sport logos or stars, favorite cartoon character, favorite actors or actresses, company logos or slogans, personal art, or other appealing images or slogans. The casing may have internal shock absorption to protect the display in the top panel and/or the bottom panel of the device, and may have a display that is specifically designed for high-impact environments. As with conventional portable computing devices, the WT can be operated from alternating current (AC) or direct current (DC). If a battery is employed, it may be housed in the WT itself, or it may be acquired by a plug-in battery supply.

The WT is also intended as a possible replacement of a client PC in a computing network implementing client/server architecture, or as a replacement of a terminal in a computing network implementing a mainframe architecture. The WT's computer interface should be able to detect when the WT is out of range, and should be able to disable the WT once this has occurred during operation. It should also be able to stop sending and/or receiving transmissions from the WT during operation or when it is not in use. The WT should preferably buffer the video data to assist terminals running on networks where the data throughput is too low to support updating the video at an acceptable rate. The WT may incorporate a mechanism that automatically repaints the screen to simulate activities such as keystrokes and mouse movement. This may be done on communication networks where the data throughput is too low to support reasonable updating of the video. For instance, consider when the user moves a mouse. Instead of the user waiting a few seconds for an update, the WT itself could determine how to repaint the screen to reflect the mouse movement in real time. The video mechanism could work in a manner where the keyboard strokes are cached and mouse movements are simulated on the WT without sending any data to the computer, until the user “clicks” on the mouse or presses the “enter” key. Once the user “clicks” on the mouse or presses the “enter” key, then the WT sends the cached keystrokes and/or mouse location to the computer for processing of the request, and the response is sent back to the WT for displaying the results.

The wireless system contemplated by the present invention may incorporate some form of digital video compression such as DVD to send the video data from the computer to the WT. Possible formats are DVD, DVI, MPEG, JPEG, JPEG2000, or other video compression formats. The wireless system could use a lossless data compression algorithm to accomplish this, or a lossy compression algorithm to achieve the desired results. The wireless system may update the video in a mechanism where the entire screen image is transmitted for the initial video update, and all subsequent updates are just refreshing the screen data that actually changed. Although not strictly required, the WT may support integration of third-party hardware and/or software implementations through plug-in or directly integrated access. The WT may also support integration of hardware such as barcode or other scanners, smart card or credit card readers, or receivers of radio wave transmission systems such as hardware based on Bluetooth technology or product tracking systems.

There are two primary types of security that are the focus of this invention, namely wireless data security on a communication network and the physical security of any device embodying the invention (such as the WT itself). The wireless security model is a model that does not broadcast any unencrypted data over a wireless channel. The physical security model is directed to tracking and locating via the Global Positioning System (GPS) any device that uses the technology described in this disclosure.

In a preferred embodiment, the wireless security model uses a client side chip to store an encryption key and encrypt the data being transmitted over the wireless network. This key is generated and configured when the system comes online. The key can be modified on a given timeframe, such as a date, to change the key used to encrypt and decrypt data over the wireless channel. The server side of this system will also have a key that gets set up when the system first comes online. From the initial configuration and during the operation of the system, all data sent over the wireless network is fully encrypted. The current 802.11 security model uses a standard security model known as Wired Equivalency Protocol (WEP) to protect data transmissions. This system has several known security weaknesses that result from the fact that some of the data used to encrypt/decrypt data is broadcast over a wireless network in unencrypted form, known as cleartext. The wireless security model described herein never sends any cleartext over a wireless network to achieve the security model.

There are several ways that a wireless security model such as this one can be implemented. One possible method would be to embed this system into a Wide Fidelity (WI-FI) network. Another method would be to implement this system in a cellular network. There are two possible scenarios for implementation. The first is to have data encrypted by the device initiating the data transfer, and have the data sent to the cellular carrier. If the data is being sent to another network that does not support the same encryption scheme, then the data can be decrypted in the secure carrier's network and sent to the other network in an unencrypted form. This would mean that the data transmission would not be protected from the secure carrier on during delivery of the data. Another implementation is to have devices on both ends of the transmission be responsible for encrypting and decrypting the data. This would allow the data to pass through the entire cellular network in a fully encrypted form, maximizing security of the data while reducing overhead required during transmission at the carrier level. All these methods would incorporate some encryption mechanism such as Secure Socket Layer (SSL), and can have a variety of different encryption protocols in use. Some of the encryption protocols used can be Blowfish, CAST, DES, triple DES, IDEA, RC2, RC4, RC5, and Skipjack, conventional encryption, MD2, MD4, MD5, RIPEMD-160 and SHA hash algorithms, HMAC-MD5, HMAC-SHA, and HMACRIPEMD-160 algorithms, and Diffie-Hellman, DSA, Elgamal, RSA public-key encryption, or elliptic curve encryption. Other security standards may also be implemented, such as ANSI X3.92, ANSI X3.106, ANSI X9.9, ANSI X9.17, ANSI X9.30-1, ANSI X9.30-2, ANSI X9.31-1, ANSI X9.42, ANSI X9.52, FIPS PUB 46-2, FIPS PUB 46-3, FIPS PUB 74, FIPS PUB 81, FIPS PUB 113, FIPS PUB 180, FIPS PUB 180-1, FIPS PUB 186, ISO/IEC 8372, ISO/IEC 8731 ISO/IEC 8732, ISO/IEC 8824/ITU-T X.680, ISO/IEC 8825/ITU-T X.690, ISO/IEC 9797, ISO/IEC 10116, ISO/IEC 10118, PKCS #1, PKCS #3, PKCS #7, PKCS #9, PKCS #10, PKCS #11, PKCS #15, RFC 1319, RFC 1320, RFC 1321, RFC 1750, RFC 2040, RFC 2104, RFC 2144, RFC 2268, RFC 2312, RFC 2313, RFC 2314, RFC 2315, RFC 2459, RFC 2528, RFC 2560, RFC 2585, RFC 2630, RFC 2631, RFC 2632, RFC 2634, RFC 2785, RFC 2876, RFC 2898, RFC 2985, RFC 2986, and RFC 3039. These encryption protocols and standards may be incorporated together in such a way as to involve multiple encryption methods in series to further increase the level of protection. The device that implements the security model may have a storage mechanism accessible in a capacity that provides write-only storage to any other electronic device or chipset. This should prevent compromising any aspect of the security model on the client device by any other means than what is known as a brute-force attack on the data transmission itself.

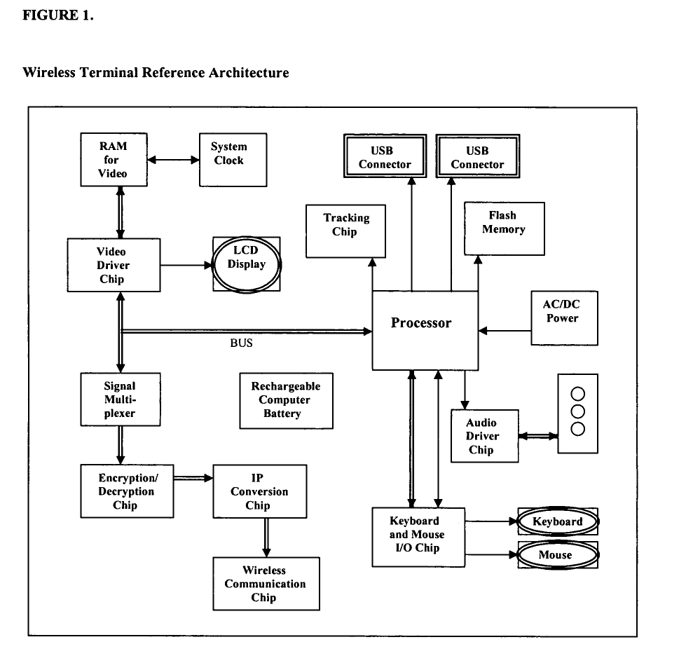

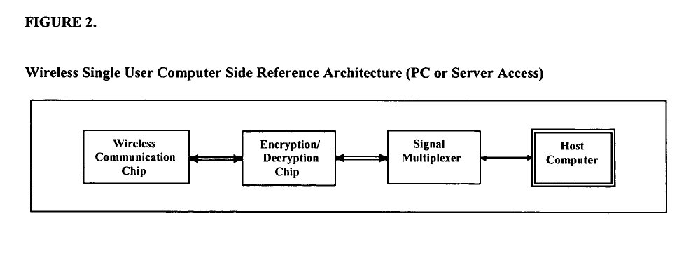

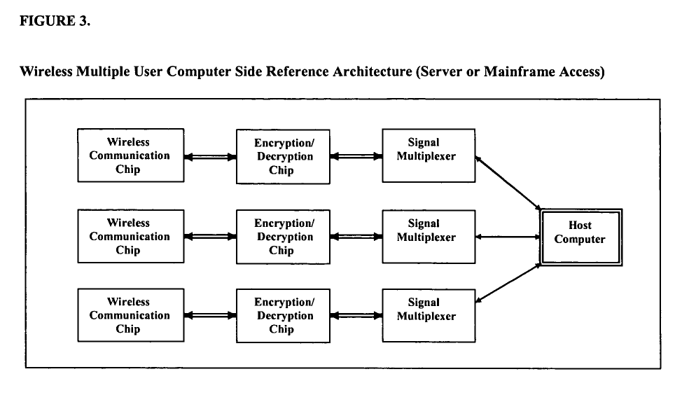

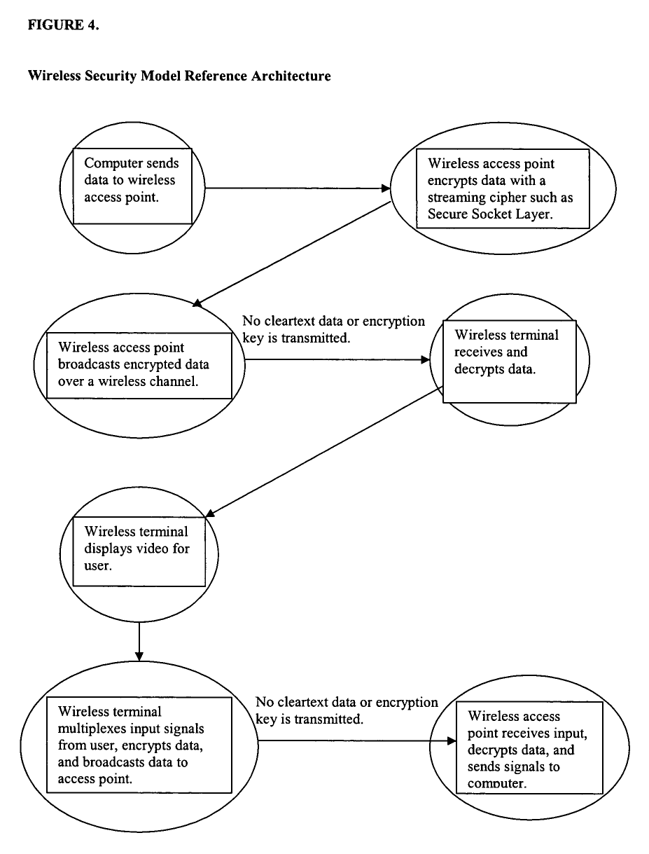

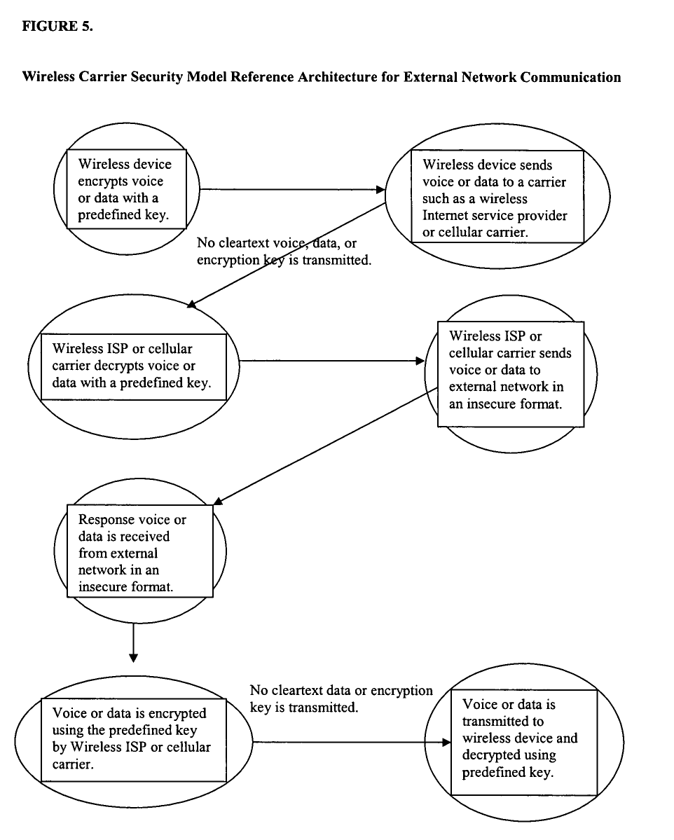

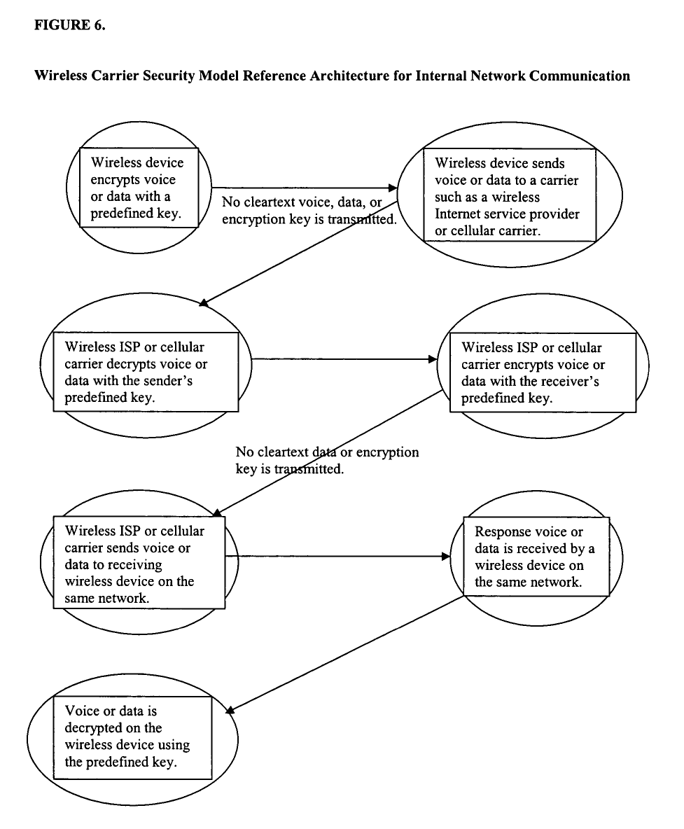

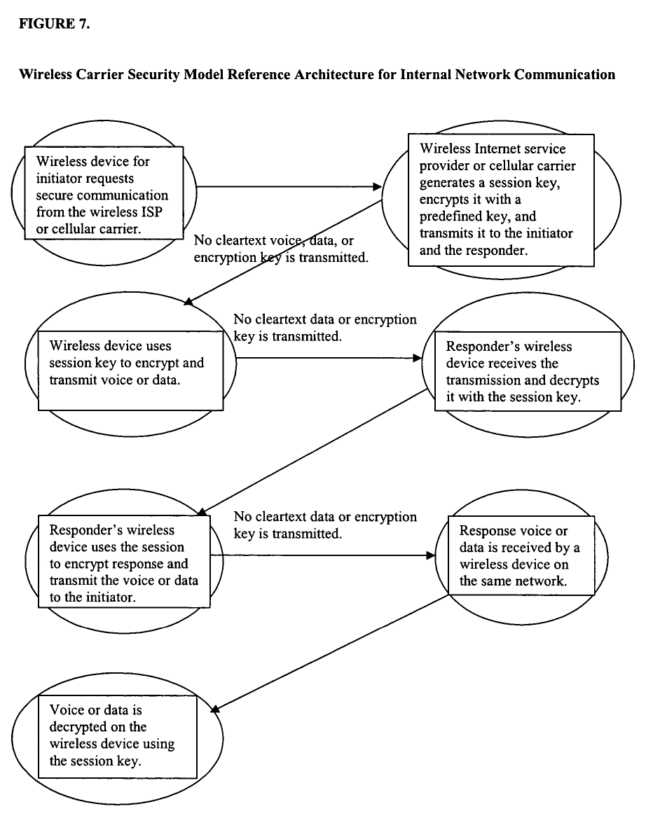

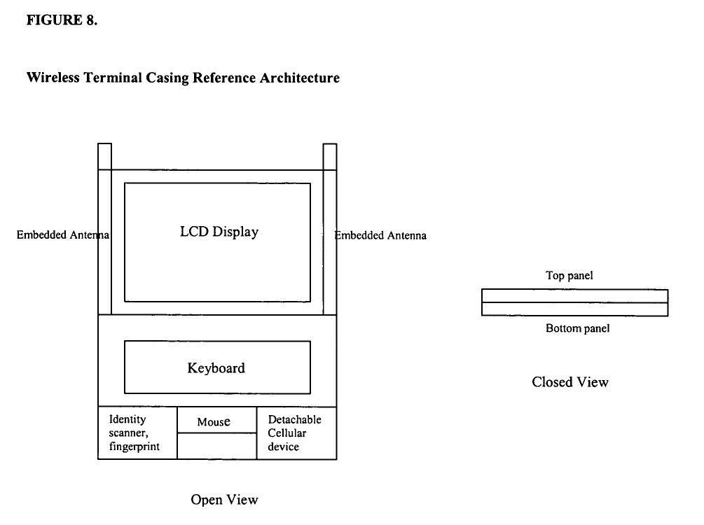

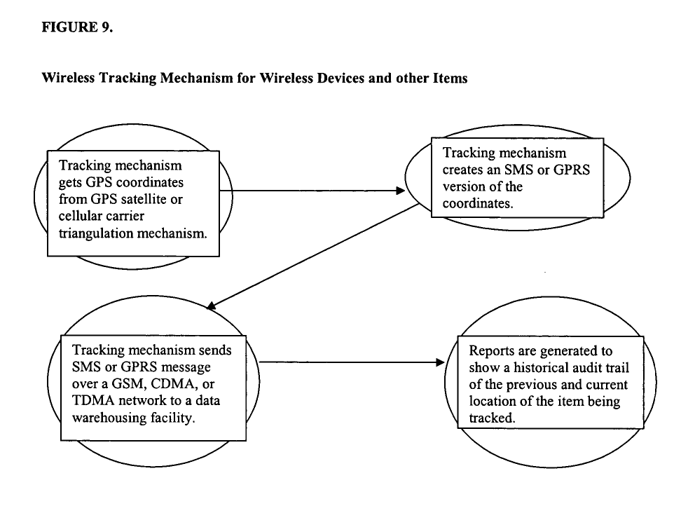

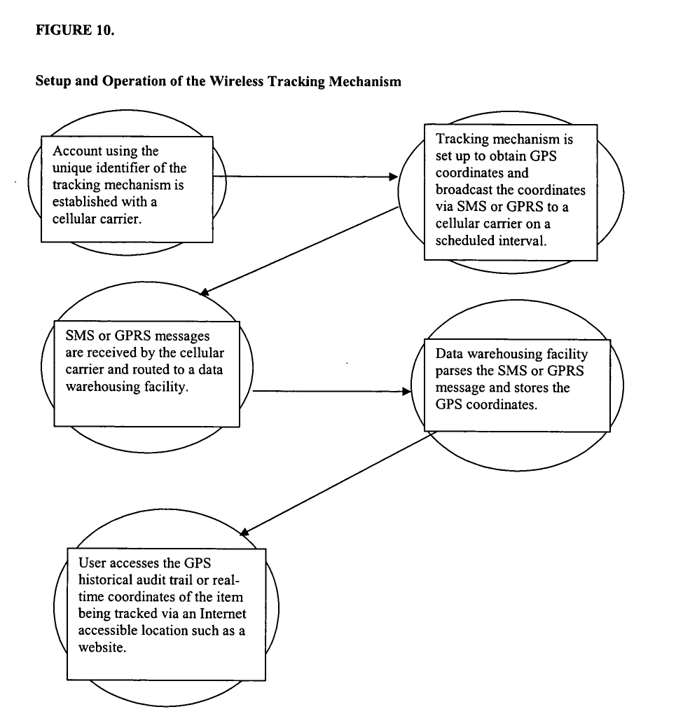

The physical security model covers using biometrics with a WT, along with using the GPS network in a new way to track and locate products using the wireless system. FIGS. 1-10 describe using fingerprinting, facial scanning, retinal scanning, and voice recognition to provide access to wireless devices, including the WT explained above. The purpose behind this verification will ensure that the WT is being accessed by the appropriate user when in operation. The tracking system has been designed to use not only existing GPS satellite transmissions to gain location, but also the new capability of the cellular networks to enable triangulation through the cellular networks using the cellular towers to gain positioning of any WT. The following section describes the features associated with any WT that implements this tracking system.

The WT's computer interface may employ an encryption mechanism to send and receive data over the network. The encryption mechanism on the computer interface may store the encryption key for a PKI encryption system in the hardware in flash ROM, inside the encryption chip itself, on the computer the hardware is connected to, or in some other storage mechanism attached to the hardware. The WT may include a “home” version that is designed to connect to a single PC or server, or multiple PCs or servers in a network environment. The “home” version of the WT may have a Secure Socket Layer (SSL) encryption mechanism. The WT may also have a “corporate” or “medical” version that is designed to connect to a single PC or server in a corporate or medical network, or multiple PCs or servers in a corporate or medical network environment, which also may have a Secure Socket Layer (SSL) encryption mechanism. Because of the unique needs of medical professionals, the “medical” version of the WT may include a 24-bit display in accordance with approval by an official medical standards board for medical diagnostics or patient-side care.

With respect to user identification features of the WT described earlier, these may include fingerprint identification, voice recognition, retinal scanning, or smart card verification. The WT's validation mechanisms described previously may be used when the device is powered up for validating the user, or may be used when the device has been inactive for a certain period of time. The WT or its computer interface may use the wireless encryption standard known as WEP, or some other proprietary security model as explained herein, to assist in securing the system. The WT and its wireless system preferably implement a security model that uses a proprietary combination of known encryption algorithms in conjunction with Secure Socket Layer and/or the Wired Equivalency Protocol.

The encryption model described previously may utilize the date to modify the encryption/decryption key itself, or it may use the date to modify the random number generator in use for the encryption/decryption algorithm's seed data. Seed data is the data used to initialize the encryption/decryption sequence. The wireless system can use an encryption mechanism that encrypts the voice or data at the wireless device using the predefined encryption keys, sends voice or data in fully encrypted voice and/or data format only, and decrypts the voice and/or data at the other end of the transmission on another wireless device. Either end of the transmission described previously can be implemented as software or hardware. The wireless system can encrypt voice or data using the mechanism described previously between the wireless device and the wireless service provider only. Instances of wireless service providers could be cellular, satellite, or Wide-Fidelity networks. The voice and/or data may be sent from a wireless service provider to another communication network that supports the same encrypted format. The voice and/or data may be sent from a wireless service provider to another communication network that may or may not support any encrypted formats at all, requiring the transmission to another network to be sent in an insecure capacity. If another communication network employs an identical encryption mechanism, then the voice and/or data may be sent to another communication network without having to change the format during transmission. The wireless system can use a security model that uses the mechanism previously described to establish links between two wireless devices upon initialization of a new communication session. The mechanism can then generate an additional session to be used by the wireless devices to encrypt/decrypt voice and/or data. The mechanism can then send the session key to each wireless device. The security model's session key can be used by the wireless devices to encrypt/decrypt voice and/or data during the communication session.

With specific reference to the tracking mechanism of the invention, there are three primary designs. One of these designs leverages one of the primary cellular communication protocols (GSM, CDMA, and/or TDMA) to enable global positioning and thus tracking of any item. Another design provides only GPS capability through a satellite linkup on the existing GPS network. The final design is a product that can utilize both cellular and satellite in any combination to perform GPS tracking of an item. The primary focus of each of these designs is to achieve the lowest power consumption and lowest cellular network usage possible to be able to use them in the widest range of applications possible. Each design is preferably implemented as an embedded chip that can be used in any electronic device, such as a WT, as well as a standalone unit that can be used in devices that have no available electronics with which to integrate.

Products which implement the tracking feature, such as WT's, should be configurable with a number of potential power supplies including AC, DC, solar, and fuel cells. Both standalone and embedded devices are preferably system-on-a-chip (SOC) designs so that they can run independent of any other devices or electronic components.

A first implementation of the tracking system does not use the Satellite GPS system directly in order to be tracked globally. Instead, it accesses only cellular technology to track and triangulate the location of the device using this chip. A WT with this type of tracking feature has the following features: (1) satellite or cellular link capability with a unique identifier such as an EIN or phone number to connect to cellular networks; (2) a built-in timer for trying to access a satellite or cellular network for updating; (3) embedded version is a SOC design so that it can be integrated into a wide range of electronics devices; and (4) embedded version has a fail-safe mechanism to prevent removing the chip from the board to which it is mounted, preferably in the form of a “callback” that is required by another chip on the board to verify that the tracking chip is still on the board; (5) standalone and/or dependent power supply to access for operation; (6) capability to perform actual phone calls to the cellular network that is performing the triangulation; (7) optional Simple Messaging Service (SMS) capability to send out coordinates of the product using the system; (8) optional General Packet Radio Service (GPRS) capability to send out coordinates from the product using the system; and (9) optional satellite communications capability to send out coordinates from the product using the system.

A second implementation may use the satellite GPS system or the cellular triangulation capability of the cellular networks in order to be tracked globally. This model is a solution that can be used in areas where cellular networks are not enabled with triangulation and such capability is not accessible. This model includes both cellular and GPS communications for tracking, primarily so that cellular networks can be used for updating coordinates to a storage facility, but can also use satellite communications to send the updates if cellular network access is not available. This implementation has the following features: (1) GPS link capability with a unique id or Globally Unique ID (GUID) to track a unique item; (2) a built-in timer for trying to access the GPS signals to coordinate updates; and (3) all of the remaining features described with respect to the first implementation of the tracking system.

A third implementation of the tracking feature uses both cellular triangulation and satellite GPS system directly in order to be tracked globally. This model is a solution that can be used in all geographic locations. This embedded chip should have all the features of the cellular and GPS products, as well as the following additional features: (1) on-board logic should first try to access a cellular provider to obtain positioning, and if not attainable, the chip should try to obtain coordinates from a GPS Satellite; and (2) either the cellular or GPS communication capability should be able to be disabled if desired by the end user.

Yet another version of the tracking facility uses the cellular network to transmit GPS related data, and it has the capability to use satellite communications to send GPS data from the same unit. These devices are used in coordination with a website and voice-activated phone system to provide enablement of the tracking feature of any device using the chips. The cellular service may be used in coordination with a cellular service provider that has triangulation capability to achieve the desired results. This system will eventually be used in a global capacity to support tracking and locating products worldwide. Like the other aforementioned versions, the tracking system's embedded version should have an optional fail-safe mechanism to prevent removing the chip from the equipment to which it is mounted. This could work in the following capacity: (1) a callback that is required by another chip on the board to verify that the chip is still on the board, otherwise the equipment should be disabled in some way to prevent removal of the chip; (2) the BIOS for the computing device the chip is connected to could have a setting to enable and disable the tracking of the device; (3) the BIOS could have logic that will check to see if the tracking chip is still connected to the board, and if not, the BIOS could disable a critical component needed for operation such as a processor required to operate the device, or the BIOS could send out an alarm noting the change to the network tracking the item; (4) the tracking chip could have the logic to check another component on the device such as a BIOS or a processor to make sure that the tracking device is still connected to the item being tracked, and send out an alarm noting the change to the network tracking the item if the tracking facility is removed, or (5) the BIOS mechanism could be password protected to prevent unauthorized access to the tracking facilities' settings.

In addition to the substantial benefits to users of the WT described herein, the tracking system can also be used for a wide variety of other applications. For example, it can be used to track lost or stolen luggage for travelers or to track shipping containers globally. The system can be used to track vehicles and construction equipment globally, or to track consumer electronic devices such as VCRs, TVs, camcorders, notebook computers, personal computers, server-level computers, stereo equipment, mail, and other electronic and non-electronic products globally. The information collected can be used to assist insurance companies in preventing insurance fraud and recovering stolen products. The military may use the system to track guns and other weapons, as well as personnel. The format of the tracking data could be standardized into a generally accepted standard for sending tracking information over a network. For instance, the latitude, longitude, and altitude could be formatted in such a way that it becomes a generally accepted standard in the GPS community, and can be used to integrate third-party products into the tracking system described here. This standardized format could be formatted in a manner that is compliant with XML or other document structures to maintain conformity across different implementations. Other data could be incorporated into the standard that would support sending other data such as temperature or pressure, velocity, power level for batteries and user defined messages over a network for tracking purposes. The XML structure could take the following format for GPS updates:

<GPS>

<PN>000000000000000</PN>
<EI>0000000000000000</EI>
<LA>000.00</LA>
<LO>000.00</LO>
<AL>000.00</AL>
<VE>000.00</VE>
<PR>000.00</PR>
<TE>000.00</TE>
<TI>000.00</TI>
<BP>000.00</BP>
<ER>000.00</ER>
<ME>000.00</ME>

</GPS>

In this sample of an XML based GPS message, the <GPS> node is the domain node, and all other nodes represent data fields of interest. The <PN> node is where the phone number is located, the <EI> node is where the EIN is located, the <LA> node is where the latitude is located, the <LO> node is where the longitude is located, the <AL> node is where the altitude is located, the <VE> node is where the velocity is located, the <PR> node is where the pressure is located, the <TE> node is where the temperature is located, the <TI> node is where the timestamp is located, the <BP>node is where the battery power is located, the <ER> node is where the error code is located, and the <ME> node is where the message is located. The XML data structures should not include any spaces or tabs to reduce the size of the message for performance and cost reduction. The nodes in this example may be shortened to one character to further reduce the size of the message. Not all fields are required for the tracking system to work properly, therefore many of the data fields in the XML standard defined above are not required such as the EIN, altitude, velocity, pressure, temperature, battery power, error code, and a message. XML formats for connecting to carrier networks via SMS or GPRS to retrieve messages in real-time can also be developed. The standardizing of GPS update formats will lead to faster global integration of disparate GPS networks, and allow this platform to integrate into a wide range of tracking solutions. The XLM formats can also be used to set up and manage accounts on the carrier network, as well as the tracking system's own infrastructure. The data sent over a network could be encrypted during transmission from the device itself or from the carrier to the tracking facility to protect access to the data used for tracking. This could require the tracking device to incorporate one of the security protocols mentioned previously in performing the security on the tracking data itself. Therefore, the tracking facility uses the same protocol to retrieve and read the data from storage.

The wireless system has a mechanism for tracking items, including the WT, over land, sea, or both geographical areas on a global scale. The tracking mechanism uses the Global Positioning Satellite (GPS) to receive coordinates, and then sends the coordinates over a GSM, CDMA, or TDMA based network via the SMS or GPRS protocol and service, or can send the coordinates via satellite communications. The tracking mechanism uses a cellular carrier's triangulation system to receive coordinates, and then sends the coordinates over a GSM, CDMA, or TDMA based network via the SMS or GPRS protocol and service, or can send the coordinates via satellite communications. The tracking mechanism is powered by a rechargeable or non-rechargeable battery, solar power system, or rechargeable battery that can be recharged, optionally with a solar power system. The item being tracked will incorporate the tracking mechanism and a security code that represents a unique ID. When the user loses or misplaces the item, they may visit the website and enter in the unique ID. This unique ID will correlate to an EIN or phone number (or any other unique identifier), which is how the cellular or satellite network currently identifies customers. This unique identifier may be unique globally, and will also represent the item in the system for GPS tracking. The unique identifier will then be used to set up an account with the cellular or satellite communications carrier. Once the account is established with the carrier, the item's location can be tracked. The tracking mechanism will be able to use the timer in the device to control when the device's location is actually determined and stored in a data warehousing facility. The location of the item being tracked can be stored by the cellular or satellite communications carrier, or forwarded to an external database to be used by the tracking website and/or voice activated system. The website, voice activated system, or wireless Internet site can then be used to produce a report of where the item is actually located. The reports can track the most recent locations, or can provide reports of where the item has been for the life of the item being tracked or the tracking device's operation. The system can serve up historical positions or real-time locations of items being tracked. If the user has more than one item being tracked, all the items being tracked can be stored and accessed by a single profile by the user or the user's company. The profiling system works in such a way as to simulate a user/group permissions policy. This policy will allow one user to track one or more items being tracked for management purposes. This tracking data can be compared to an item's normal route to see if the item is on schedule or not. This tracking data can also be used by businesses and government workers to determine how to perform their job more effectively. For instance, ambulance providers can route a particular ambulance to a location based on how close the vehicle is to the device sending the coordinates. Also, additional measurements such as temperature and pressure of an item the device is tracking can be sent to the data warehouse and retrieved for use in the client side interface of the system. The tracking system can use a network that uses a Wide-Fidelity communication protocol to send GPS coordinates from an item being tracked to a receiver that will then broadcast the GPS data over a cellular network to perform updates and track the item.

Another potential use for the tracking facility will be to enable the tracking unit to receive digital bar-coding information from radio devices and broadcast the digital bar-coding information along with GPS coordinates to the tracking system's data warehousing facility for tracking purposes. This setup could be used on a truck cab, trailer, or shipping container to track individual packages on the cab, trailer, or container by GPS location. In this scenario, one GPS unit could facilitate tracking of several items simultaneously. The GPS updates could bundle several digital bar-codes in one transmission to enable this functionality.

The data storage facility for the tracking system can retrieve data from a cellular network via SMS or GPRS or some other data protocols, as opposed to voice transmissions, satellite communications networks, or from an Internet enabled network through some other delivery method. This may be done using one of the security algorithms mentioned in the security models mentioned previously. It may also retrieve the data via electronic mail (email), where the communications network forwards the coordinate data to an email account, and the tracking facility retrieves the email and parses out the GPS coordinates. The email can be retrieved via MIME or S/MIME format, possibly over SSL or HTTP via the Internet. The email can be accessed over POP3, IMAP, or SMTP protocols in a secure or insecure fashion. The email will be retrieved from or pushed from the carrier network to the tracking system's data warehouse. The mechanism that retrieves the email from the carrier network could run in a single-threaded or single-process processing model via computer software or hardware. The email retrieval mechanism could also run as a multi-threaded or multi-process processing model via computer software or hardware. The computer software or hardware mentioned above could be a single processor or multiple processor computing architecture (sometimes referred to as an SMP architecture). It will store this data in a “non-tamperable” data warehousing facility. By “non-tamperable” we mean that the data is stored in such a way that the data itself cannot be modified and/or removed from the data storage facility. This may be accomplished by several mechanisms. One is that no person has access to the data warehousing facility except the operator of the service, and their access to the data is monitored so no tampering can occur. Another mechanism is that the data is stored in such a way that cannot be easily modified from its original form in a way that the stored data can be changed. This is accomplished by storing the data such that no software-based viewer such as a hex editor can be used to read the data directly, allowing only the software or hardware that is storing the data to access the data. Another property of this system is that the permissions are set up in the computing environment such that no one can access the file system that the data is being written to by any means other than the software itself, which prevents any modifications or deletion of data from the data warehouse. The data could also be written to encrypted drives to enhance the security of the system. The system will support querying and reading the data out of the data warehouse, but only in a controlled capacity. Once the data is stored in the “non-tamperable” data warehouse, it will then be transmitted securely to a database such as Oracle, SQLServer, DB2, or any other mainstream database product located on a different computer or network. The mainstream database's table structure for the GPS data will include fields to store the telephone number, EIN (the carrier's internal unique id), latitude, longitude, altitude, velocity, timestamp, pressure, temperature, battery power level, external error code, external error message, internal error code, internal error message, and a general message. The primary key for the table will be the telephone or the EIN. A foreign key can be whichever unique id is not a primary key, either the telephone or the EIN. The database table structures will also include user profile data, information about the item being tracked, and account management information which includes user access rights to account information. The client for this system may be an Internet-based website, or a thin client using a programming language such as Java. The client will not have to maintain a constant Internet Protocol (IP) address or other type of connection to the server to receive GPS or other data-related updates from the network. In doing so, the server side of the system may have to maintain status of each client and reference the client via an IP address. The server will create a new connection to the client only when updates need to be sent. The client will incorporate a mapping feature, as well as routing information to support tracking of items being delivered. The items may be tracked globally. The routing information can be used along with the GPS information to determine if an item is being delivered efficiently. When the item being tracked goes overseas, the hardware may store up GPS coordinate information, and send several GPS location updates to the network when the hardware device comes within range of a cellular network, possibly in an incoming port or harbor. The hardware could also use HAM radio to send updates when the item being tracked is over water (ocean or lake). The HAM radio could use the registered HAM frequency range to broadcast the data, or it could use a frequency outside of the registered HAM frequency range that the HAM radio can still use. HAM radios can transmit and receive data outside of the registered HAM frequency range, and this mechanism would allow for a dedicated HAM frequency to be used for the tracking system. On ships, a cellular or Wi-Fi receiver could be connected to a computer that can store the GPS updates. This would allow the GPS updated being sent by the tracking device to get stored while over water, and the stored date could be uploaded when the ship comes into port and is within range of a cellular carrier. Reports for the audit trail of the item's location could be sent via email on the user's demand, or could be scheduled to be sent on regular intervals to further enhance the tracking platform. This computer will support access from the Internet, WAP enabled device, or voice activated system to allow access to the information from users of the tracking system.

The tracking system will support automating the account setup process, storing the data in a “non-tamperable” data warehousing facility, and monitoring the items being tracked. This entire system may be provided as standalone services or as a bundled package. The bundled package should facilitate everything the user requires to use the tracking system as one package, which can be sold as a monthly service fee, or as a leasing option. The monthly or leasing options may include replacement of the tracking equipment for the user of the system. The “non-tamperable” data warehousing facility will be used to submit data to legal entities for official proof of the tracking data being collected. This data can be used by law enforcement to support a case, or by insurance companies in identifying fraudulent claims. It may also be used by customers of the tracking service to be able to support claims in a legal environment such as a court system or legal proceeding. The reporting facility may work in the following described manner.

In a preferred embodiment, tracking software developed in accordance with the present invention is designed to operate on a personal computer running the Windows NT/2000/XP operating system. It will track and log all GPS messages produced by the hardware tracking solution (referred to herein as the “TerraTrace” system), in files stored in the GAMPNT\RECORDS directory. The tracking system is referreed to in this disclosure as a Global Asset Management Platform, or GAMP. An Hourly History record is kept for the GAMP GPS Records in the GAMPNT\HISTORY directory for use in the History and Schedule Reports. Several methods of access are provided to retrieve the stored information.

The GPS Record LOGGER

In this embodiment, the LOGGER is a software program that is started when the PC is first turned on and operates in the background in a multiple process environment to receive data from the TerraTrace tracking network and log all GPS Records in the appropriate files. The GPS Records are maintained in two files which may named in the following exemplary fashion:

GPS Information MMMYYYY.GPS

USER Information MMMYYYY.USR

MMM=Three character month (JAN-DEC)

YYYY=Four character year (1970-3000)

These files are in a structured format and should not be modified by any type editor. The History Records are maintained in files and are named as MMMYYYY.HST with MMM and YYYY having the same meaning as described above for GPS Records. History files are created by the LOGGER program as GPS Records are received. The History file for a month contains the history for each day, by the hour, for every day of the month. This file eliminates the time intensive search of GPS Records to calculate a report. Some common instructions for the reporting mechanism are discussed below:

Common Search Time Screen

Start Date End Date

00/00/0000 00/00/0000

Start Time End Time

00:00 00:00

This is the time span one wishes to search for GPS record information for the function that has displayed this screen. The Browse and Print radio buttons select the type of output desired. If Browse is selected, the report or data will be displayed on the screen for browsing. If Print is selected the report or data will be printed on the default printer. If the Print Radio Button is checked a Type Of Printout panel will be displayed for the items listed below except for the Trunk Usage Report and Position Usage Report. This is a common search time screen used by the following functions to obtain a start and end search time from the user:

BROWSE GPS RECORDS

TRUNK USAGE REPORT

POSITION USAGE REPORT

EXCESSIVE GPS DURATION REPORT

EXCESSIVE GPS HANDLING TIME REPORT

GPS TRANSFERS REPORT

NO GPS DATA REPORT

This screen will display the information of the last transaction that required input from this screen. The user completes the requested information, selects type of results and clicks “OK” to process the information or Quit to leave the screen and abort the request.

Printer Options are as follows. If one clicks the Print radio button in the Results box of the Search Time Screen, a Type Of Printout box will be displayed. The following three types of printouts may be selected:
(1) GPS Summary—Include in the printout the GPS data and Summary of all the GPS records in the pattern or search time.
(2) Summary Only—Print only a Summary of the GPS records in the pattern or search time.
   Preferably, a main menu provides the following items:

System Administration

Reports

Trunk Usage

Position Usage

History

Daily History Report

Monthly History Report

Year To Date History Report

Previous Year History Report

Shift

Daily Shift Report

Weekly Shift Report

Monthly Shift Report

Excessive GPS Duration

GPS Transfers

Abandon GPS Data

No GPS Data

GPS Records

Options

Special Database Directory

About

Exit

The System Administration item allows the user to set up the system configuration for proper operation of the software. The Reports section is used to generate various reports from the GPS Records and History Files in the following manner:

(1) GPS Records—used to Browse GPS Records and/or Search for GPS Records using a Time Range and Search Pattern.

(2) Options—used to Select an optional directory for archived GPS Records and History Files.

(3) About—Displays Version of Software.

(4) Exit—Exits the Main Menu.

The instructions section could include the following menu items:

(1) System Administration—This item allows the user to set up the system configuration for proper operation of the software.

(2) Number of Trunks—Total number of incoming GPS Trunks on the GPS Network.

(3) Starting Trunk Number—The first Trunk number of the GPS Network.

(4) Number of Positions—Total number of Positions on the GPS Network.

(5) Starting Position—The first Position of the GPS data.

(6) Excessive Holding Time—The amount of time, in seconds, to be considered excessive delay time for a GPS update message.

(7) Excessive GPS Handling Time—The amount of time, in seconds, to be considered excessive network response time.

(8) Printer Point Size—The character size to be used by the printer to print reports and GPS records.

(9) GPS Abbreviated GUID—The Globally Unique Identifier is the unique identifier used by the TerraTrace network for a single GPS record. If the GUID is a phone number, it is used to represent up to four (4) Area Codes. The user enters the Area Code for each Abbreviated GUID that are coming into the GPS network.

GPS ABBREVIATED GUID

0/4 Area Code 1
1/5 Area Code 2
2/6 Area Code 3
3/7 Area Code 4

(10) Operator Schedules—The work schedules of the operators. The user enters a start and end time, using 24 hour clock, for each schedule of the TerraTrace GAMP operators. Six (6) Operator Schedules are provided to allow the System Administrator to have four (4) hour shifts for each day. Any number of the Schedules may be assigned a start and end time. All un-used Schedules should be given a start AND end time of 0000. The Operator Schedules will be the same for each day of the week.

SCHEDULE

NUMBER Start End

1 0000 0000

2 0000 0000

3 0000 0000

4 0000 0000

5 0000 0000

6 0000 0000

(11) Comm Port—The COMM Port of the computer that is to be connected to the printer port of the TerraTrace network to collect GPS Records.

(12) Baud Rate—The Baud Rate of the COMM Port above. This should be baud rate of the printer port of the TerraTrace network.

(13) Data Bits—The number of Data Bits used on the printer port of the TerraTrace network.

(14) Stop Bits—The number of Stop Bits used on the printer port of the TerraTrace network.

(15) Parity—The Parity used on the printer port of the TerraTrace network.

The user Completes each item and clicks Save to save System Administration Parameters or clicks Exit to quit System Administration without changing anything.

The Reports feature supports the following capability:
Reports/Trunk Usage—Select the Reports/Trunk Usage item of the MAIN MENU to display the Search Time Screen for Trunk Usage. Fill in the desired Start and End times as described in the Common Search Time Screen of this document and Click OK. Provides a TRUNK USAGE report with following information about each trunk assigned in the System Administration menu:
Number of Trunk Seizures—Average Holding Time of Each Trunk
Number of Abandon GPS updates for Each Trunk—Percent Handled—Percent of the total GPS updates for the time period requested that each trunk has handled.
Percent Utilized—Percent of the time period requested that the trunk was in use.
Number of Excessive GPS Duration's for Each Trunk—Excessive GPS Duration time is defined by the user in the System Administration menu.
Reports/Position Usage—Select the Reports/Position Usage item of the MAIN MENU to display the Search Time Screen for Position Usage. Fill in the desired Start and End times as described in the Common Search Time Screen of this document and Click OK. Provides a POSITION USAGE report with the following information about each Position assigned in the System Administration menu:
Number of Seizures of Each Position—This number is different from the Seizures in the Trunk Usage report as it is the number of times that each position has been involved in a GPS update.
Average GPS Handling Time of Each Position—Number of Excessive GPS Handling Time of Each Position
Average Holding Time of Each Position—All the time spent on each GPS update is included in this item whether the position was the first to collect the GPS data or not.
Excessive Holding Time of Each Position—The time period used to define Excessive GPS Handling is provided by the user in the System Administration menu.

The Reports/History/Daily History Report may work in the following manner:

Select the Reports/History/Daily History Report item of the MAIN MENU to display the DAILY HISTORY REPORT Screen. Enter the Date of the desired day of the report and Click the Screen Key to display the report or the Printer Key to print the report. The day of the report should be entered in the following format:

MM/DD/YYYY—Where MM is a 2 character Month, DD is a 2 character Day, and YYYY is a 4 character Year.

This report provides a daily history of GPS Records in the following format:

TIME EACH HOUR (0000-0100)

PERCENT TOTAL—The percent of total GPS updates of this day that was handled each hour.

NUMBER OF GPS UPDATES HANDLED LESS—Number of GPS updates handled

THAN OR EQUAL TO 5 SECONDS—for each hour that had a GPS update time less than or equal to 5 seconds.

NUMBER OF GPS UPDATES HANDLED LESS—Number of GPS updates an operator

THAN OR EQUAL TO 10 SECONDS—handles for each hour that had a GPS update time less than or equal to 10 seconds.

NUMBER OF GPS UPDATES HANDLED LESS—Number of operator

THAN OR EQUAL TO 20 SECONDS—handled for each hour that had a GPS update time less than or equal to 20 seconds.

NUMBER OF GPS UPDATES GREATER—Number of operator GPS updates for each hour

THAN 20 SECONDS—that had an update time greater than 20 seconds.

AVERAGE GPS UPDATE TIME—average GPS update time for each hour of the day.

AVERAGE HOLDING TIME—The average Holding time for each hour of the day.

NUMBER OF GPS Updates—The number of GPS updates transferred out for TRANSFERRED OUT each hour of the day.

The Reports/History/Monthly History Report feature works in the following manner:

Select the Reports/History/Monthly History Report item of the MAIN MENU to display the MONTHLY HISTORY REPORT screen. Enter the desired month and Click the Screen Key to display the report or the Printer Key to print the report.

The month of the report should be entered in the following format:

MM/YYYY Where MM is a 2 character Month, and YYYY is a 4 character Year

This report provides the same information as the DAILY HISTORY REPORT except that it is displayed and calculated for each week of the month.

The Reports/History/Year to Date History Report feature works in the following manner:

Select the Reports/History/Year to Date History Report item of the MAIN MENU to display the YEAR TO DATE HISTORY REPORT screen. Click the Screen Key to display the report or the Printer Key to print the report. This report provides a daily history of GPS Records in the following format:

MONTH By month for each month to the current month.

MONTHLY GPS UPDATES Number of GPS updates handled for each month.

CHANGE Change from previous month GPS updates. A + or − will indicate if the change is more or less than last month.

AVERAGE GPS UPDATE TIME Average GPS update time for each month.

CHANGE Change from previous month average GPS update time. A + or − will indicate if the change is more or less than last month.

AVERAGE HOLDING TIME Average holding time for each month.

CHANGE Change from previous month average holding time. A + or − will indicate if the change is more or less than last month.

The Reports/History/Previous Year History Report feature works in the following manner:

Select the Reports/History/Previous Year History Report item of the MAIN MENU to display the PREVIOUS YEAR HISTORY REPORT screen. Enter the desired year and Click the Screen Key to display the report or the Printer Key to print the report. This report is identical to the YEAR TO DATE HISTORY REPORT except that it is the complete previous year. The Reports/Shift/Daily Shift Report feature works in the following manner:

Select the Reports/Shift/Daily Shift Report item of the MAIN MENU to display the DAILY SHIFT REPORT screen. Enter the date of the desired day and Click the Screen Key to display the report or Printer Key to print the report.

The day of the report should be entered in the following format:

MM/DD/YYYY Where MM is a 2 character Month, DD is a 2 character Day, and YYYY is a 4 character Year.

This report provides a Daily Shift Report in the following format:

SHIFT The hours of the shift.

TOTAL GPS UPDATES Total number of GPS updates handled for the shift.

PERCENT TOTAL Percent of the GPS updates of the day that was handled by this shift.

NUMBER OF GPS UPDATES LESS Number of GPS updates during this shift that were THAN OR EQUAL TO 5 handled in 5 seconds or less. SECONDS

NUMBER OF GPS UPDATES LESS Number of GPS updates during this shift that were

THAN OR EQUAL TO 10 handled in 10 seconds or less.

SECONDS

NUMBER OF GPS UPDATES LESS Number of GPS updates during this shift that were

THAN OR EQUAL TO 20 handled in 20 seconds or less.

SECONDS

NUMBER OF GPS UPDATES Number of GPS updates during this shift that were

GREATER THAN 20 SECONDS handled in over 20 seconds.

AVERAGE GPS UPDATE TIME FOR Shift Average GPS Update time.

THE SHIFT

AVERAGE HOLDING TIME FOR The average processing time during this shift.

THE SHIFT

NUMBER OF GPS UPDATES The total number of GPS updates that were TRANSFERRED OUT FOR transferred out during this shift.

THE SHIFT

The Reports/Shift/Weekly Shift Report feature works in the following manner:

Select the Reports/Shift/Weekly Report item of the MAIN MENU to display the WEEKLY SHIFT REPORT screen. Enter the date of the Sunday of the desired week and Click the Screen Key to display the report or Printer Key to print the report. The week of the report is the date of a SUNDAY and should be entered in the following format:

MM/DD/YYYY Where MM is a 2 character Month, DD is a 2 character Day, and YYYY is a 2 character Year.

The format for this report is the same as the DAILY SHIFT REPORT except that it is reported by each day of the week, Sunday through Saturday. The Reports/Shift/Monthly Shift Report feature works in the following manner:

Select the Reports/Shift/Monthly Shift Report item of the MAIN MENU to display the MONTHLY SHIFT REPORT screen. Enter the desired month and year and Click the Screen Key to display the report or Printer Key to print the report. The month of the report should be entered in the following format:

MM/YYYY Where MM is a character Month, and YYYY is a 4 character Year.

The format of this report is the same as the DAILY SHIFT REPORT except that it is reported by the STANDARD Week. The STANDARD Week is the weeks of the month in seven (7) day increments regardless of which day of the week the month starts. The Reports/Excessive GPS Duration feature works in the following manner:

Select the Reports/Excessive GPS Duration item of the MAIN MENU to display the Search Time Screen for Excessive GPS Duration.

MIS REPORT MENU.

Fill in the desired Start and End times as described in the Common Search Time Screen of this document and Click OK. This report provides access to the actual GPS Records that have Excessive GPS Duration. The time period that defines an Excessive GPS Duration is provided by the user in the System Administration menu. The instructions for the Start Search and End Search time are described in the Common Search Time Screen paragraph of this document. When the EXCESSIVE GPS DURATION report is displayed on the screen the instructions for this screen are defined in the BROWSE GPS RECORD section of this document. The Reports/Excessive Handling Time feature works in the following manner:

Select the Reports/Excessive Handling Time item of the MAIN MENU to display the Search Time Screen. Fill in the desired Start and End times as described in the Common Search Time Screen of this document and Click OK. This report provides access to the actual GPS Records that have Excessive Handling Time. The time period that defines an Excessive Handling Time is provided by the user in the System Administration menu. If the report is displayed on the screen the BROWSE GPS RECORDS paragraph describes the use of the display of the report.

The Reports/GPS Transfers feature works in the following manner:

Select the Reports/GPS Transfers item of the MAIN MENU to display the Search Time Screen. Fill in the desired Start and End times as described in the Common Search Time Screen of this document and Click OK. The Search Time Screen will provide the ability to search for a particular Transfer to Position Number for this report. If you wish to search for a particular Position that GPS updates were transferred to enter the Position Number in the space provided and Click the Search For A Pos. No. Check Box before you Click the OK button. This report provides access to the actual GPS Records that have a GPS Transfer entry in them. If the report is displayed on the screen the instructions for the display is described in the BROWSE GPS RECORDS section of this document.

The Reports/Abandon GPS Data feature works in the following capacity:

Select the Reports/Abandon GPS Data item of the MAIN MENU to display the Search Time Screen. Fill in the desired Start and End times as described in the Common Search Time Screen of this document and Click OK. If the report is displayed on the screen the instruction for the display is described in the BROWSE GPS RECORDS section of this document.

The Reports/No GPS Data feature works in the following manner:

Select the Reports/No GPS Data item of the MAIN MENU to display the Search Time Screen. Fill in the desired Start and End times as described in the Common Search Time Screen of this document and Click OK. If the report is displayed on the screen the instruction for the display is described in the BROWSE GPS RECORDS section of this document.

The GPS Records feature works in the following manner:

Select the GPS Records item of the MAIN MENU. Fill in the desired Start and End times as described in the Common Search Time Screen of this document and Click OK. A Search Pattern is provided on the Search Time Screen for this item to allow the user to search for particular items within a GPS Record. The Search Pattern is described below. If the report is displayed on the screen the instruction for the display is described in the BROWSE GPS RECORDS section of this document.

Search Pattern:

The user may search for the following items:

Telephone Number: This is a telephone number including the Area Code and Country Code which you wish to find in the GPS Records.

Trunk Number: This is any Trunk in the range defined in the System Administration Menu that you wish to find in the GPS Records.

Position Number: This is any Position Number in the range defined in the System Administration Menu that you wish to find in the GPS records.

Search Pattern: This is a string of characters that you wish to find in the User field marked with YES on the SEARCH PATTERN Screen. If a Search Pattern is entered you must use the UP and Down Arrows to select a User field to search for the string of characters. Use the Space Key to set the selected user field to YES or NO. In the Browse Mode portions of the first line of the GAMP GPS Record are displayed on a single line to allow the user to Browse the records of the selected time period and search pattern.

The GPS RECORDS Screen contains the following information:

GUID TRK DATE ORIG TIME POS TIME POS TIME DISC TIME

GUID The unique identifier used by the TerraTrace network.

TRK The Trunk number of the GAMP that received the GPS update.

DATE The Date the GPS was received.

ORIG TIME The time the GPS originated on the Trunk.

POS The First position information of the GPS line of the GPS Record received from the GAMP.

TIME The time information of the First position of the GPS Record received from the GAMP.

POS The Second position information of the GPS line of the GPS Record received from the GAMP.

TIME The time information of the Second position of the GPS Record received from the GAMP.

The Options feature works in the following manner:

Options provides a method to change the Database Directory. The user may specify where the software should look for archived data. This may be a different disk drive or a different directory on the same disk drive. GPS Record information is stored in two (2) different directories on the system:

One where the MMMYYYY.GPS and MMMYYYY.USR files are located which contain the user information and the user profile information respectively.

Another where Hourly History records are stored for the GPS Records. (Files MMMYYYY.HST)

On the Options Screen you may enter a Directory other than the ones described above and enter ‘Y’ in the USE ARCHIVE DIRECTORY field. The System will use the new directories you have entered until the Options Screen is selected again and ‘N’ is entered in the USE ARCHIVE DIRECTORY field.

The BROWSE GPS RECORDS feature works in the following capacity:

Print A GPS Record—Click on a displayed GPS Record to Highlight it then Click the Print Key. See the Print The GPS Record section of this document.

Display Full GPS Record—Click on a displayed GPS Record to Highlight it then Click the Full Display Key. You may also Double Click on the desired GPS Record to display the Full GPS Record. See the Display Complete GPS Record section of this document.

Display Search Results Status—To display the status of the Search Time and Pattern by Click the Display Status Key. See the Display Search Time And Pattern section of this document.

Quit Browsing—Click the Quit Key.

The Display Complete GPS Record feature works in the following manner:

The complete GPS record may be displayed while in the GPS RECORDS screen by first Clicking on a GPS Record to select it then Click the Full Display button. You may also display the Full GPS Record if you Double Click on the GPS Record. This will display the complete line one information of the GPS Record along with the user information, if provided by the GAMP. To return to the Browse mode Click the Browse button or Click on the screen of the Full Display.

The Display The Search Time and Pattern feature works in the following manner:

The Search Time and Pattern may be displayed while in the GPS RECORDS screen by Display Status button. The Display Search Time information contains the status of the search time in three fields:

STATS OF SEARCH

Total CRCDS:

Total Match:

Percent Match:

Other information may be displayed if search patterns are active or an archive directory is selected. To exit the Search Time and Pattern display Click the OK button of the display. The GPS Record may be printed to the printer defined in the System Administration Menu.

The system can also be used as a standalone unit to provide the tracking features to other devices not associated with the WT. For the standalone tracking unit, it may incorporate a weatherproof or waterproof housing to protect the internal components from damage during operation. The casing may house a battery, rechargeable or non-rechargeable, and will have the tracking technology mounted to an electronics board inside the housing, or to the housing itself. It may require antennas for the embedded versions, as well as for the standalone versions of the tracking facility.

These followings claims include significant characteristics of the overall architecture, the unique software features, the tracking features, the security and system facilities, and other novel aspects of this invention. While the invention is described with reference to the preferred embodiments thereof, various modifications and changes may be made by those skilled in the art without departing from the true spirit and scope of the invention as defined by the claims thereof.

What is claimed is:

1. A wireless terminal device for use in a wireless system, wherein said wireless terminal device is communicatively connectable to a host computer, comprising:
(a) a case having a power supply and means for accepting input from a user, wherein said input is directed to said host computer through a switching device connected to said host computer;
(b) a visual display of information responsive to said input;
(c) control functionality and memory relating to operations of said wireless terminal device, said control functionality and memory mounted to said case; and
(d) means, mounted to said case, for transmitting and receiving signals formatted for digital Internet Protocol (IP) data capable of being routed over a computing network, wherein said signals include an identification of said wireless terminal device; and
wherein said wireless terminal device is caused to emulate the operation of said host computer.

2. The wireless terminal device of claim 1, further comprising a data storage device.

3. The wireless terminal device of claim 1, further comprising a hard drive.

4. The wireless terminal device of claim 1, further comprising flash memory.

5. The wireless terminal device of claim 1, further comprising a keyboard.

6. The wireless terminal device of claim 1, further comprising an input device for moving a cursor on said visual display.

7. The wireless terminal device of claim 1, wherein said visual display is a liquid crystal display (LCD).

8. The wireless terminal device of claim 1, further comprising a sound output device connectable to internal or external speakers.

9. The wireless terminal device of claim 1, further comprising one or more external hardware interfaces selected from the group consisting of keyboard, mouse, video, Universal Serial Bus, serial, parallel, fiber, component, RJ45, RJ232, RJ11, PS2, and sound.

10. The wireless terminal device of claim 1, further comprising one or more antennas to transmit and receive said signals.

11. The wireless terminal device of claim 1, further comprising an embedded central processing unit (CPU) having a software operating system.

12. The wireless terminal device of claim 1, further comprising a standard central processing unit (CPU) in communication with a software operating system stored on an attached hard drive.

13. The wireless terminal device of claim 1, wherein a plurality of said transmitted or received signals are multiplexed.

14. The wireless terminal device of claim 1, wherein said case comprises at least two hinged panels, and wherein a first said panel includes a keyboard, and a second said panel includes said visual display.

15. The wireless terminal device of claim 1, wherein said power supply is capable of accepting alternating current (AC) or direct current (DC).

16. The wireless terminal device of claim 1, wherein said power supply is a battery.

17. The wireless terminal device of claim 1, further comprising a Secure Socket Layer (SSL) encryption mechanism.

18. The wireless terminal device of claim 1, further comprising a WEP encryption model.

19. The wireless terminal device of claim 1, further comprising a public key infrastructure (PKI) encryption model, and wherein a key for encryption and decryption of said signals is stored in said memory.

20. The wireless terminal device of claim 1, wherein said visual display is a 24-bit color display.

21. The wireless terminal device of claim 1, further comprising identification means for authenticating a user, and wherein said identification means includes fingerprint identification.

22. The wireless terminal device of claim 1, further comprising identification means for authenticating a user, and wherein said identification means includes voice recognition.

23. The wireless terminal device of claim 1, further comprising identification means for authenticating a user, and wherein said identification means includes retinal scanning.

24. The wireless terminal device of claim 1, further comprising identification means for authenticating a user, and wherein said identification means includes smart card verification.

25. The wireless terminal device of claim 1, wherein video data is buffered in said memory.

26. The wireless terminal device of claim 1, further comprising tracking means for tracking said wireless terminal device on a global scale.

27. The wireless terminal device of claim 26, wherein said tracking means employs the Global Positioning Satellite (GPS) to receive coordinates and sends said coordinates over a GSM, CDMA, or TDMA based network via the SMS or GPRS protocol and service.

28. The wireless terminal device of claim 26, wherein said tracking means employs the Global Positioning Satellite (GPS) to receive coordinates and sends said coordinates via satellite communications.

29. The wireless terminal device of claim 26, wherein said tracking means employs a triangulation system of a cellular carrier to receive coordinates and sends said coordinates over a GSM, CDMA, or TDMA based network via the SMS or GPRS protocol and service.

30. The wireless terminal device of claim 26, wherein said tracking means employs a triangulation system of a cellular carrier to receive coordinates and sends said coordinates via satellite.

31. The wireless terminal device of claim 26, wherein said tracking means employs a system on a chip (SOC) design.
